(19) United States
(12) Patent Application Publication
(10) Pub. No.: US 2020/0070637 A1
(43) Pub. Date: Mar. 5, 2020

(54) TEMPORARY PROTECTIVE ENCLOSURE

(71) Applicant: ClimaGuard LLC, Dover, DE (US)

(72) Inventor: Rahel Abraham, Sugar Land, TX (US)

(21) Appl. No.: 16/557,955

(22) Filed: Aug. 30, 2019

Related U.S. Application Data
(60) Provisional application No. 62/724,736, filed on Aug. 30, 2018.

(51) Int. Cl. B60J 11/04; B32B 5/02

(52) U.S. Cl. CPC B60J 11/04; B32B 5/024; B32B 2307/546; B32B 2571/00; B32B 2605/00; B32B 2307/7265

(57) ABSTRACT

The present invention is a temporary protection enclosure and method of its use. The enclosure is mostly made of a waterproof material and when fully closed, will limit or omit outside water entry, as well as provides areas to attach an anchoring device. This enclosure is designed to allow an individual to setup the device on their own, to provide protection for personal possessions stored within it from outdoor weather conditions such as flooding. This enclosure includes handle that offer a way for the user to attach an anchoring tether to a stationary object. This enclosure may be used to protect material possessions outdoors or indoors, and when not needed, it may be folded and stored.

### CROSS-REFERENCE TO RELATED APPLICATION

This application claims the benefit of and priority to U.S. Provisional Application Ser. No. 62/724,736 filed on Aug. 30, 2018 which is incorporated herein in its entirety by reference.

### BACKGROUND OF INVENTION

This invention relates to protection of assets and bulky items from environmental catastrophes such as flash floods, hurricanes, and flooding. It is estimated that over 41 million Americans currently live in areas prone to flooding. Providing those residents with a means to protecting their possessions, such as their automobile vehicles, helps to mitigate the economic damage caused by those disasters.

Many a time, when an environmental disaster occurs in residential areas, people evacuate the area leaving their valuable possessions behind. Those possessions are left to the mercy of the environment and often times are destroyed. The resulting economic impact is tremendous, measuring up to the tune of billions per year. In some areas, this is an annual occurrence and frequently, the insurance companies no longer insure people's property due to the risks involved. With global warming, this is even a higher concern for those affected by lack of insurers and the inability to protecting their assets.

Therefore, a means by which an average person can provide safety of their vehicles and valuables is of great importance. The invention covered in this application proposes such a solution that is available for use once disaster warnings are communicated to the public.

Various solutions have been proposed by others that provide some measure of protection although each has a deficiency which this invention aims to address.

On such solution proposed is by Battle in U.S. Pat. No. 4,315,535A that describes a flexible material which covers the outside of the car. The flexible material has a drawstring all around its opening that once tightened, closes access to the flexible material. The flexible material there is made of some rubber which is impermeable to water. The concept here is to place the flexible material on the ground and drive a vehicle unto its center using the guide marks. Then the user pulls the drawstring to enclose the vehicle with the flexible material and tighten the top to ensure water tightness. However, this solution does not incorporate a more modern enhancement such as use of a zipper with a tight seal. The material used here is heavy in nature and it does not provide for safely securing the vehicle to anchors. Thus, the vehicle is at risk of being washed away once the enclosure is engaged.

Another solution proposed by Echauz in U.S. Pat. No. 9,061,808B2 employs a “pillowcase” design with a flexible material. It is envisioned to be made of some polymer such as PE (Polyethylene) of up to 380 micrometers (μm). The “pillowcase” design has an opening on one side where all the other three sides are closed by heat treatment. The open end has a perpendicular line opening from the midsection which provides a wider access for vehicles to drive into. The openings are closed with a zipper and/or hook-and-loop combination. Then the corners are bunched up at each end and tied to one another. Furthermore, this design incorporates anchoring lines to secure the flexible material and its contents to a stationary object such as a tree or a post. However, this design does not incorporate heat welded handles in various places of the vehicle that can be used for both tightly securing the contents as well as being used for anchoring means. Moreover, this design has the anchoring tethers attached to the material which makes it prone to being ripped due to the item being impacted by other object and/or it bobbing about when floating over water. Furthermore, this design is heavy and requires more than one person to operate. Commercial versions of these products are available at the following URLs [www.floodguardph.com, www.floodycarbag.com].

Another solution is envisioned by Lerner in U.S. Patent Application Publication 2016/0368,357A1 where another “pillowcase” design protects a vehicle when it is driven into it. This design also requires a two-person team to accomplish its goals. This design also employs the use of three closed sides with one side being open that can be closed with use of a zipper. However, this design lacks any handles or anchoring points, leaving the contents inside the pillowcase to be washed away as flood waters penetrate into urban areas and then recede.

In another publication, covered by Allain in U.S. Pat. No. 6,405,862B1 which incorporates a flexible bag and a protective cover. One is placed from underneath the car and a draw string is sued to cinch it down at the top of the vehicle and another one is placed from atop and cinched down from the bottom. This design further envisions grommets that can be used to secure the contents of the bag in place, however, no handles are incorporated in this design. Furthermore, this design is prone to having the fabric be punctured and torn at the place of its grommets. Once rapid waters push and pull on the floating vehicle, the fabric and the anchor point on the fabric are exposed to great forces endangering the structural integrity of the waterproof enclosure. This design however does not incorporate the use of handles.

Yet another solution is proposed by Su in U.S. Pat. No. 6,517,141B1 whereby rigid plastic sheets are connected and enclosed to form a watertight seal. The plastic sheets come together and mate with one another using some type of zipper, zip-lock mechanism and/or hook-and-loop fastener. The whole enclosure also employs a release valve at the top of the structure to allow for air to escape. Furthermore, this design uses suction cups attached to tethers in order to hold down the structure in place by anchoring it to some objects. However, this solution is impractical as it is bulky and can not be stowed away in a compact way. Furthermore, this design uses suction cups for attachment points in the structure that may be prone to being dislodged causing the structure to float away. Finally, this design lacks handles and is not made of a flexible material.

Another solution proposed by Streyckmans in U.S. Pat. No. 6,273,113B1 shows a drive-in cover that is used to house a vehicle. The covers are made of rugged materials such as Kevlar. The vehicle drives over the top bottom portion of the cover and then the sides are raised and closed with the top part. The two portions are sealed using a zip-lock fasteners system. The top portion also has a vent installed in order to release excess air built up in the enclosure. The whole enclosure is anchored down with use of two straps, an oversized screw to tie it down to the ground. However, this design is faulty in that it is bulky, heavy and has limited range with regard to its anchoring abilities. This design also lacks anchoring handles.

Another solution proposed by Sebera in U.S. Patent Application 2009/0008,958A1 shows a “pillowcase” type car cover with one side entry. The cover is envisioned to be made of some polymer such as plastic or PE. The cover is water impermeable and can withstand different temperature ranges. The cover also can employ water ballasts which act as anchors when it floods. It can also use a desiccant to dehumidify the inside compartment where the vehicle is housed. The cover is sealed using some adhesive or some other type of closure such as zipper or zip-lock mechanism. The cover may also have handles that are used to anchor it to a stationary object. However, the cover still requires two people to deploy. Furthermore, the cover does not show that the handles may be located at various places along the material to allow for flexible attachment of the anchoring tethers. Finally, the anchoring tethers do not wrap around or hug the whole vehicle to keep the whole unit from floating away or tearing the handles that are intended for securing in place the whole system.

Finally, another solution is proposed by Chen in 2006/0225,822A1 where a more rigid material, such as rubber or plastic (based trough an upper cover) are connected via a zipper band to encapsulate a vehicle. The enclosure is shown to have handles that nylon bands run through in order to secure it to an anchoring point. However, the solution does not show whether this is a lightweight enclosure, has high water resistibility, that where the anchoring tethers tightly wrap around the car to make it more secure, weather the material is made of recyclable PE and what thickness it employs.

### SUMMARY OF INVENTION

According to an embodiment of the present invention, the water impermeable enclosure is made of a flexible polyethylene (PE) material designed to withstand high pressures and abrasive nature of driving a vehicle on the material. The enclosure can be made of segments and those segments bound together by heat welding to makeup the side walls, the floor mat, and the top cover. The seals can be further reinforced by applying PE tape along the seams and heat welding them to maintain better structural integrity and superior water impermeability. Alternatively, the enclosure can be made of one whole piece with the opening cut in the top portion to allow for vehicle ingress and egress.

An embodiment of the present invention also uses a zipper mechanism to close the top cover with the rest of the enclosure that makes up the walls and the bottom. The zipper allows for the enclosure to have a wide opening for the car to enter through by driving the car over the side walls and unto the floor mat. The bottom of the enclosure also has guide marks that direct the driver to place the vehicle in between or center it so that its positioning allows for the walls to easily wrap or cover over the vehicle inside the enclosure. The bottom of the enclosure or floor mat can also be of a thicker PE material than the rest of the enclosure to provide a longer usage-life. Because tires of a vehicle provide pressure on the floor mat and the floor mat comes into contact with the ground, it would be prone to abrasion and being puncture. For that reason, a higher thickness material and/or higher quality PE is contemplated. Furthermore, when the top cover is connected with the bottom half of the enclosure, the zipper track is also covered by a flap, made of a PE material, that can have a hook-and-loop fastener to provide further protection against water intrusion. Alternatively, the immediate vicinity of the zipper can be made of a semi permeable material to allow air and moisture to escape form inside of the enclosure, but also to keep water molecules from penetrating into the enclosure. Such a material can be Gore-Tex®, which allows water vapor and air to pass through but is a barrier against water molecules. The flap can also be made of the same semi permeable material which allows air to pass through but blocks water molecules from penetrating into the temporary protective enclosure.

An embodiment of the present invention also integrates handles that are heat welded unto the walls and the top cover of the enclosure. The handles can be made of nylon, polymer or a sturdy fiber such as Deena®, Technora® or Kevlar®. These handles serve a few roles. One is to use it in deploying the enclosure as well as for repackaging it into a duffel bag. The second is to be a limiter for the anchoring tethers when the anchoring tethers are wrapped around the enclosure and connected to a stationary object. The handles are placed in strategic parts of the enclosure to allow for use with a variety type of bulk objects or vehicles including automobiles, trucks, SUVs, ATVs, motorcycles, boat and jet ski trailers, small tractors, lawnmowing machines and golf carts or the like.

An embodiment of the present invention employs the use of anchoring tethers to tightly bind the vehicles located inside the enclosure and to anchor it to a stationary object such as a tree or a light post. The anchoring tether may be made of conventional webbing cord, or from a fiber similar to the ones used to construct the handles. The ends of the tethers may have an opening ring, clip or carabiner style latch. One end of the tether uses a latch to be affixed unto another part of the tether once it is “snaked” through sufficient handles of the enclosure to complete the loop. The other end of the tether uses a latch to be affixed unto another part of the tether once a segment of the tether is wrapped around a stationary object. Thus, this versatile system allows the user to adjust, wrap the tether and snake it around its respective body, whether it is the enclosure or the stationary object, in order to have a taught and tensioned anchor lines.

An embodiment of the present invention envisions using recyclable materials to constitute the flexible material used for the enclosure. For example, plastic cartons can be used to make the material of the enclosure in order to reuse materials that would otherwise be disposed of. Nevertheless, the construction of the material is robust enough to allow the user to redeploy and use the temporary protective enclosure multiple times as well as store away for several years.

Finally, the temporary protective enclosure is deployed by a singled user with ease. The user takes temporary protective enclosure out of its protective bag. Then the user lays the temporary protective enclosure down on the ground with the top upper cover facing upwards. Then the user unzips the cover to expose the opening of the temporary protective enclosure. The user then drives a vehicle over the temporary protective enclosure (using the guidelines) to center the vehicle over the floor mat. Alternatively, the user can move valuable objects into the temporary protective enclosure, laying them on top of the floor mat. Then the user raises the flexible walls over the contents of the temporary protective enclosure and zips the cover to the bottom half of the temporary protective enclosure. The user can also close the flap on the edge of the cover and fasten it with the hook-and-loop fastener.

Then the user takes an anchoring tether and loops it around the object sliding the anchoring tether through the handles. Once it is wrapped, the end carabiner is then clasped unto the anchoring tether closest to the temporary protective enclosure. The user then takes the other end of the anchoring tether and wraps it around a stationary object such as a light post. After tightly wrapping the anchoring tether around the light post, the user connects that free end, with a carabiner, unto the end of the anchoring tether closest to the stationary object. The user repeats the anchoring steps using another anchoring tether to secure and relatively immobilize the contents of the temporary protective enclosure.

### BRIEF DESCRIPTION OF THE DRAWINGS

The invention will be further described by reference to the accompanying drawings wherein:

FIG. 1 is a top-down view of the temporary protective enclosure in an opened state.

FIG. 2 is a top-down view of the temporary protective enclosure in a closed state.

FIG. 3 is a side view of the temporary protective enclosure.

FIG. 4 is a partial side view of the temporary protective enclosure that is partially opened revealing the vehicle inside it.

FIG. 5 is a side view of the temporary protective enclosure with the inserted anchoring tether in one area.

FIG. 6 is a top-down view of the temporary protective enclosure showing two anchoring tethers “snaked” through the enclosure and attached to anchoring posts for security.

FIG. 7 shows a top-down view of the anchoring tether with typical carabiners attached on both ends.

FIG. 8 is a summarized illustration of the method of deploying the temporary protective enclosure.

### DETAILED DESCRIPTION

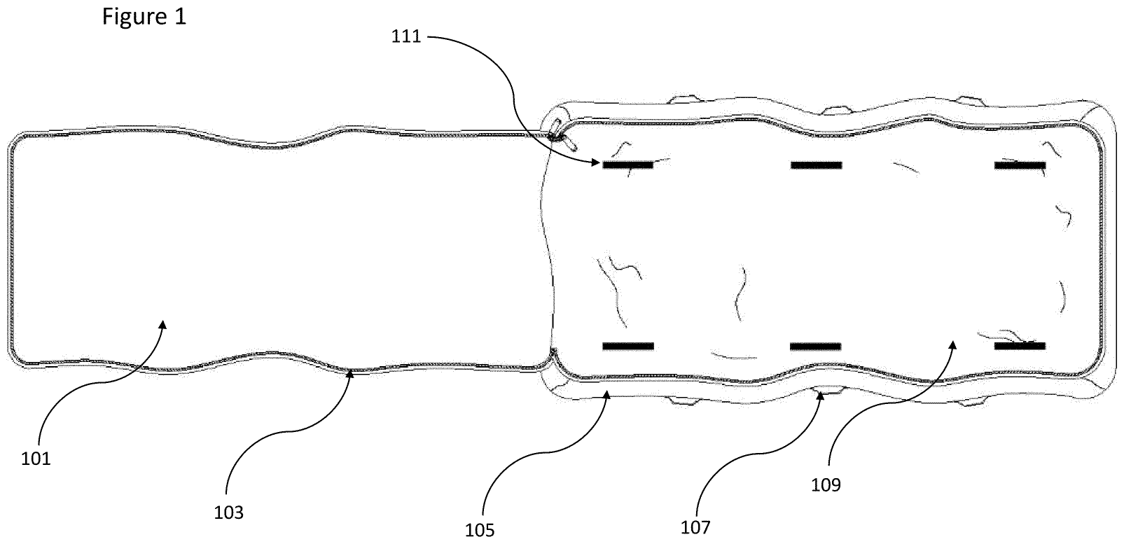

The present invention, as shown in FIG. 1, illustrates the temporary protective enclosure that has an upper top cover 101 that closes over the bottom part 105. The upper top cover 101 and the bottom part 109 can be made of a flexible material that is strong enough and waterproof enough to withstand a flooding scenario. In some embodiments the upper top cover 101 and the bottom part 105 are made of some polymer material. In some embodiments the polymer used is a polyethylene (PE) with a water impermeability rating of at least 5,000 mmH₂O and a maximum of 9,800 mmH₂O, with an average measurement of 7,200 mmH₂O. The typical temporary protective enclosure can have PE thickness of at least 400 micrometers (μm). The PE material can be made of recyclable goods such as used water bottles and milk jugs. In some embodiments the PE material is woven and laminated at about 200 g/m². In some embodiments, the PE material is composed of a woven mesh inner layer and laminated outer layers that provides it with the necessary waterproofness while adding tensile strength and tear resistance compared to simply using a PE film. These parameters provide the temporary protective enclosure with the utmost balance of weight-to-water-impermeability ratio. A typical temporary protective enclosure weighs about 20 lbs. and performs well when deployed.

In some embodiments, the bottom part 105 is made of one unitary material and in some other embodiments, segments of the PE material are heat welded together to encompass the temporary protective enclosure. The segments of the PE material are any of the four walls and the floor mat 109 that can be unified to make the bottom part 105. As stated before, the segmented pieces of the temporary protective enclosure have edges that somewhat overlap one another and are heat welded for durability and water impermeability. Furthermore, these overlapping sections are also heat welded with a waterproof PE taping material on the inner seams of the enclosure. In another embodiment, both the inside and the outside of the temporary protective enclosure may be sealed using the waterproof PE taping material. The added PE tapes provide a more robust interconnection between the segments and ultimately increases the hydrostatic pressure limit of the whole temporary protective enclosure during a flooded application. In some embodiments, it is envisioned that the high-grade PE chosen for the temporary protective enclosure is laden with an abrasive protective material suitable for the bottom part 105 or the surface sides of the floor mat 109. This is to ensure that the floor mat 109 does not puncture or wear-off easily when a vehicle is driven over it and/or reused. Furthermore, the inside of the floor mat 109 may have guide marks 111 which are meant to aid the driver in maneuvering the vehicle on top of the floor mat 109. These guide marks 111 can be reflective in nature in case the driver is approaching unto the floor mat 109 in a dark setting.

The rim portion of the bottom part 105 incorporates a zipper 103 fastening mechanism which is met with the other half of the zipper 103 mechanism on the rim of the upper top cover 101. Once the two halves, the upper top cover 101 and the bottom part 105 come together and line up at the rim portion, the zipper 103 can be used to close the temporary protective enclosure. The zipper 103 is specifically placed as high as possible in the temporary protective enclosure to provide for as high a level of water submersion as possible. The zipper 103 can make a water-resistant seal enclosing the contents of the temporary protective enclosure. Usually a vehicle will be driven unto the floor mat 109 when the temporary protective enclosure walls are draped down to the floor and the upper top cover 101 is opened. To further provide a water seal, the zipper 103 may be draped with a flap (not pictured) which would cover and hide the intersection of the two joined sections, the upper top cover 101 and the bottom part 105. That flap, made of the high-grade PE material, could further have a hook-and-loop fastener or Velcro® on the inside of the flap which would attach to the bottom part 105 of the temporary protective enclosure. Within the immediate vicinity of the zipper 103, a material can be incorporated to allow for breathability of the temporary protective enclosure. However, that material would be designed such a way as to allow for moisture, water vapors, and air to escape from inside the temporary protective enclosure and dispel any water molecules from penetrating inside the temporary protective enclosure. Such a material can be made of Gore-Tex® or its equivalent. In other embodiments, the flap can also be made of the same breathable material. In some embodiments, the upper top cover 101 may have an inner layer or pockets to insert thin felt-type fabric or a padding to provide for protection of the vehicle from possible objects falling unto it such as hail or tree branches, etc.

The temporary protective enclosure also has handles 107 that are strategically placed on three to five sides of the temporary protective enclosure. These handles 107 may be made of the same PE material as the temporary protective enclosure is made of. Alternatively, the handles 107 may be made of double-lined or ultra-strong polypropylene, nylon, polyester or a sturdy fiber such as Deena®, Technora® or Kevlar®. The handles 107 are also welded or sewn unto the various parts of the temporary protective enclosure and its seams (not pictured) are heat welded as well. This is to ensure that the handles 107 and its seams do not become a source of leakage in the temporary protective enclosure. The handles 107 serve a few useful purposes. One, the handles 107 allow the user to manipulate and spread out the components of the temporary protective enclosure. Second, the handles allow the user to easily re-package and stow away the temporary protective enclosure. Third, the handles 107 provide a “track” to enable the user to guide the anchoring tethers (not pictured) through them and to tighten the temporary protective enclosure around the vehicle when securing it to a stationary object without pulling on the enclosure material. Because the anchoring tethers actually grip the vehicle or asset that is inside the temporary protective enclosure, the handles 107 provide a means of making sure that the anchoring tethers do not move or slip out. Fourth, during a flood, the temporary protective enclosure and components stored within it will become buoyant. If the user choses to relocate the enclosure, they can grab the handle and pull it in the desired direction with ease.

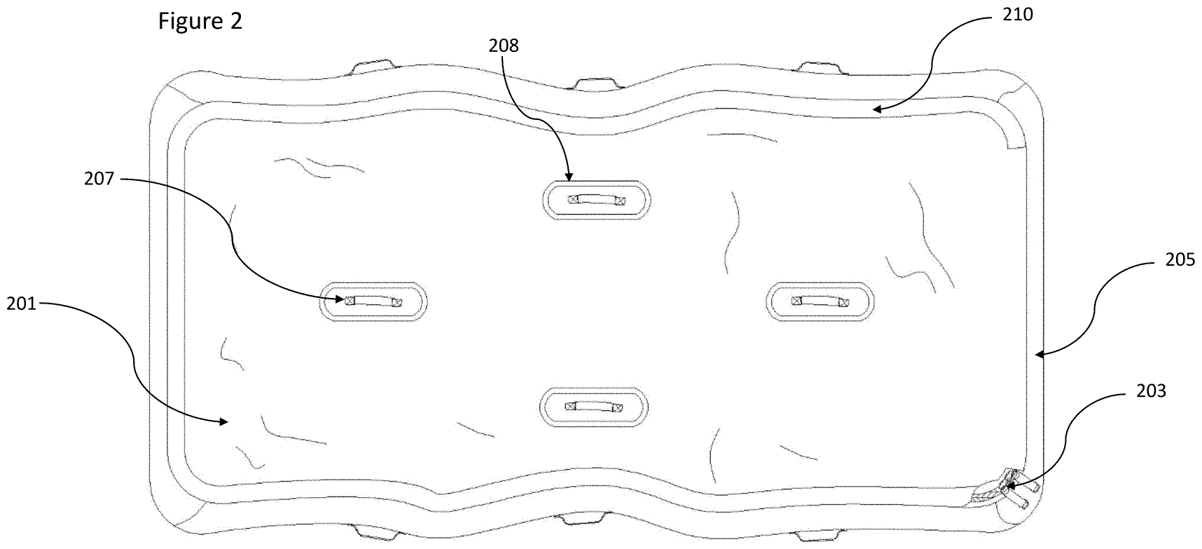

The present invention, as shown in FIG. 2 illustrates the temporary protective enclosure in a closed state. The handles 207 are incorporated unto the upper top cover 201 on the temporary protective enclosure in a particular pattern. In this embodiment, the handles 207 are laid out in a diamond shaped patter; however, other variations can be contemplated. Furthermore, the handles 207 are surrounded by the seam 208 which is heat welded unto the temporary protective enclosure. The zipper 203 mechanism has been engaged and the two halves of the temporary protective enclosure, the upper top cover 201 and the bottom part 205 have been united to make up the whole of the temporary protective enclosure. Moreover, the zipper 203, is covered with the flap 210 which drapes over it and further seals the zippered opening. As stated before, the flap 210, can have hook-and loop type fasteners or Velcro® installed on the inside part of the flap 210 and the outside edge of the bottom part 205 in order to seal the flap 210 shut over the zipper 203.

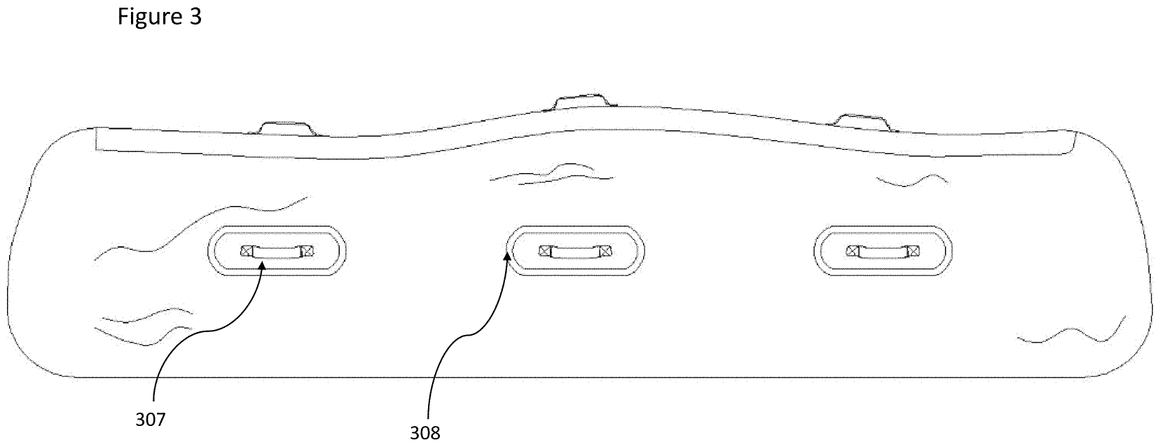

The present invention, as shown in FIG. 3 illustrates the temporary protective enclosure from its side view. The handles 307 are heat welded unto the sides of the temporary protective enclosure in a particular pattern. The double lining seams 308 of the handles 307 also show how the temporary protective enclosure integrates another layer of material to provide for superior level of water impermeability.

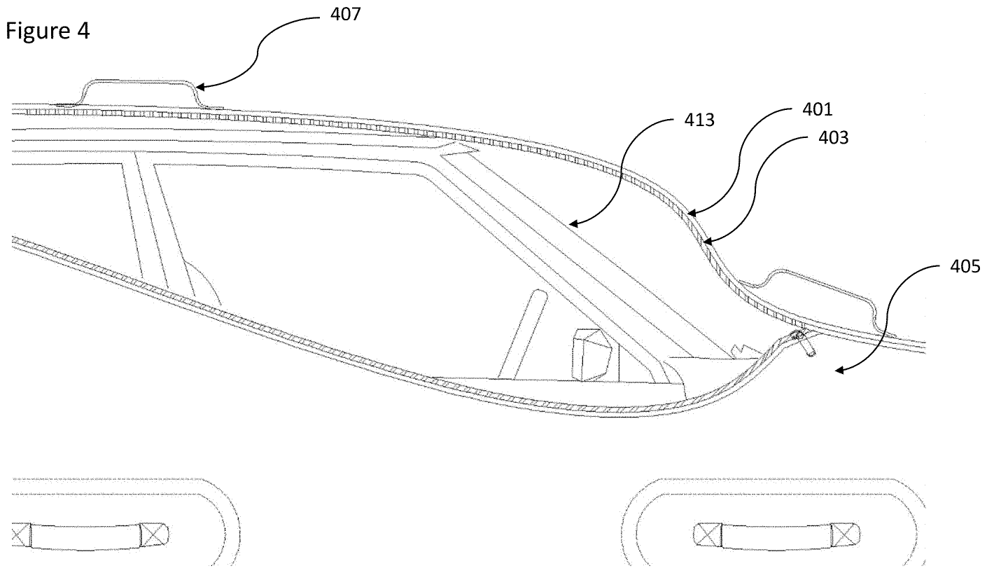

The present invention, as shown in FIG. 4 illustrates a partial view of the temporary protective enclosure which already has a vehicle 413 inside it. As can be seen, the vehicle 413 can be completely covered up with the temporary protective enclosure. Once the upper top cover 401 and the bottom part 405 meet together and the zipper 403 mechanism is used to fasten the two halved of the temporary protective enclosure together, the vehicle 413 becomes encased in the temporary protective enclosure. Although in this illustration, only a vehicle 413 is showed as being protected by the temporary protective enclosure, any bulky item such as a boat, trailer, SUV, small tractor, golf cart, household furniture or the like, can be enclosed in the temporary protective enclosure. It is envisioned that the temporary protective enclosure can come in various sizes to accommodate for the user's needs. A bigger sized temporary protective enclosure with higher length, width and height dimensions can be used to encapsulate a bigger object whereas a smaller sized the temporary protective enclosure can be used for smaller objects. The handles 407 are also shown that may be used to guide the anchoring tethers at different points in order to secure the temporary protective enclosure to a stationary body such as a lamp post or a tree.

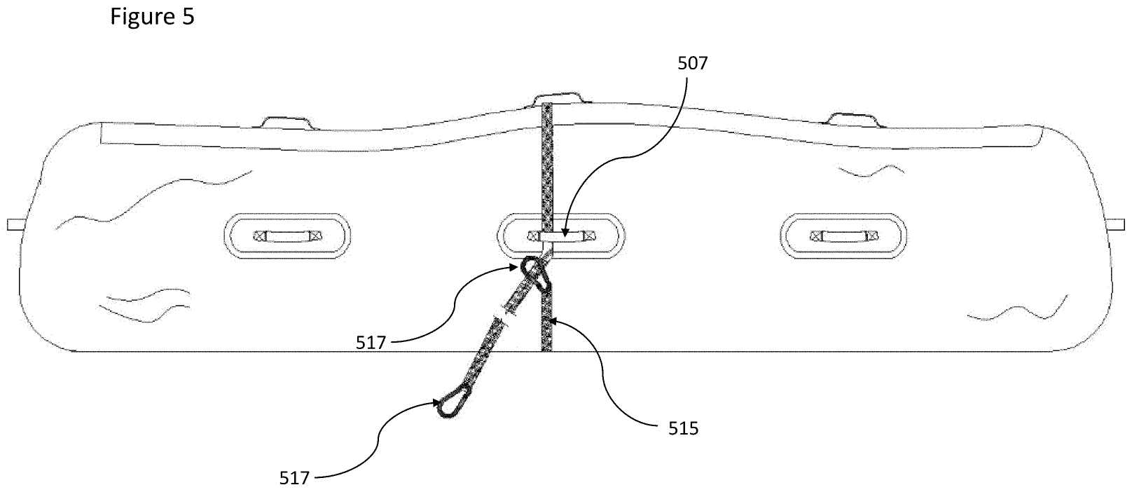

The present invention, as shown in FIG. 5 illustrates a side view of the temporary protective enclosure with the anchoring tether 515 attached to it. The anchoring tether 515 can be made of an ultra-strong webbing material such as a nylon or the same material that the handles 507 are made of. The anchoring tether 515 has two ends, one end has a carabiner 517 attached to it which is used to loop it unto the anchoring tether 515 that wraps around the temporary protective enclosure and another end with a carabiner 517 attached to it which is used to wrap the anchoring tether 515 around a stationary object and then clasp the carabiner 517 unto the anchoring tether 515. The anchoring tether 515 wraps around the object placed inside of the temporary protective enclosure when the anchoring tether 515 is guided through the various handles 507 located on the temporary protective enclosure. The handles 507 keep the anchoring tether 515 from slipping off of the object located inside the temporary protective enclosure. Once the anchoring tether 515 is guided through the handle 507, that side attaches to the free side of the anchoring tether 515 with the use of the carabiner 517. The other side of the anchoring tether 515 is reserved for attaching unto a stationary object such as a tree or a light post.

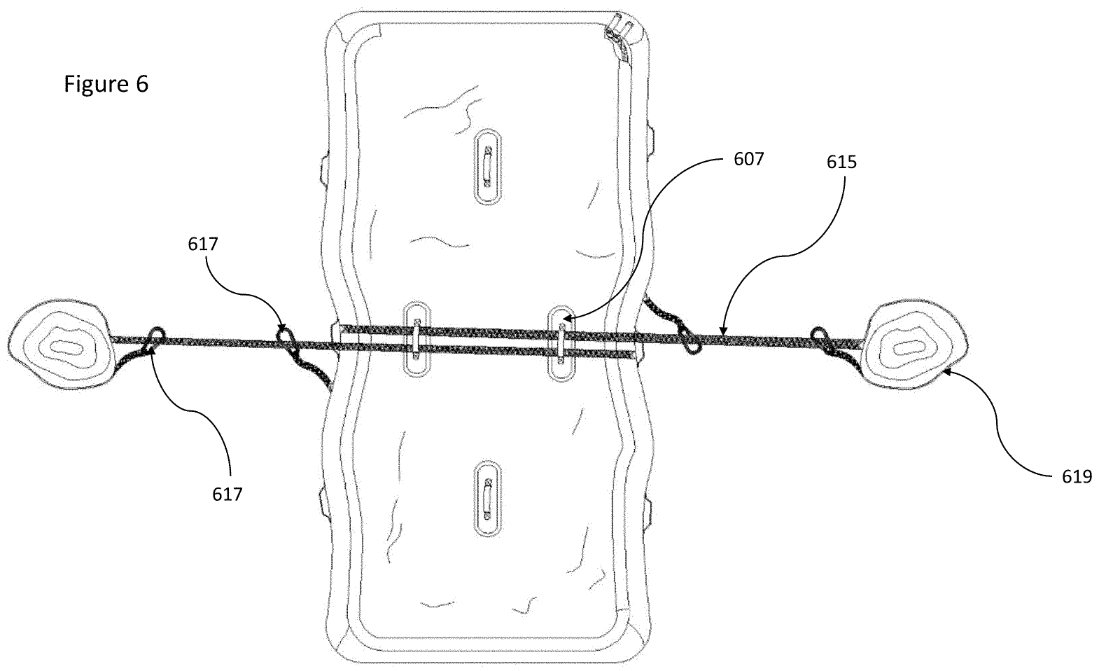

The present invention, as shown in FIG. 6 illustrates a top-down view of the temporary protective enclosure with two anchoring tethers 615 attached to the temporary protective enclosure. The right anchoring tether 615 is guided through the handles 607 from the top and the two sides of the temporary protective enclosure. This anchoring tether 615 has its end carabiner 617 clasped unto the anchoring tether 615 closest to the temporary protective enclosure. Once that closed loop is made, the other side of the anchoring tether 615 is wrapped around a stationary object such as a tree trunk 619. A number of wraps is made to be sufficient enough to keep the anchoring tether 615 as taught to allow the anchoring tether 615 to tightly grab around the temporary protective enclosure and limit the movement of the temporary protective enclosure. Then, that end of the anchoring tether 515 has another carabiner 617 which is clasped unto the anchoring tether 515 itself. The same routine is performed on the left anchoring tether 615, which completely immobilizes the temporary protective enclosure and the contents within it in the horizontal plane.

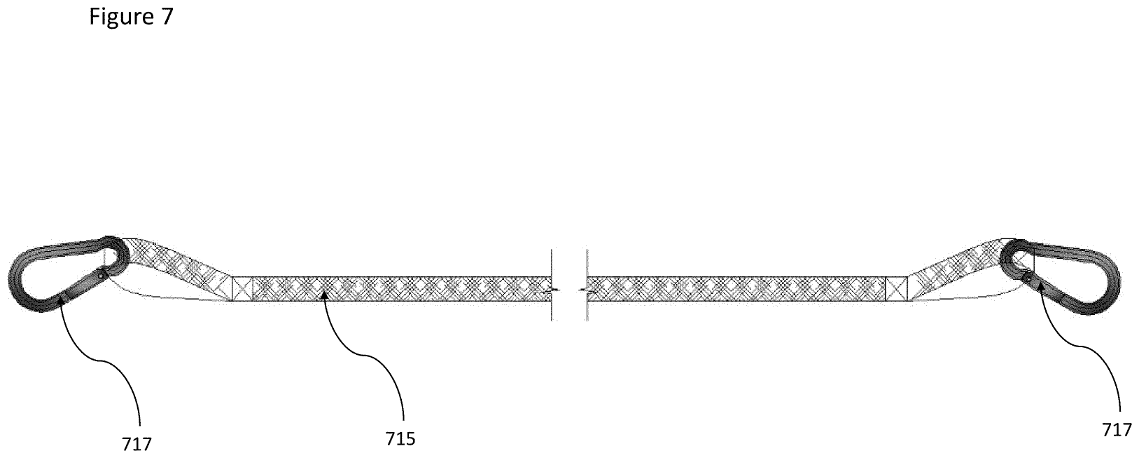

The present invention, as shown in FIG. 7 illustrates a preferred embodiment of the anchoring tether 715 with the two carabiners 717 installed on its end. The carabiner 717 can be made of a metallic material such as stainless steel or a composite material that is sufficiently strong to provide for a suitable anchor.

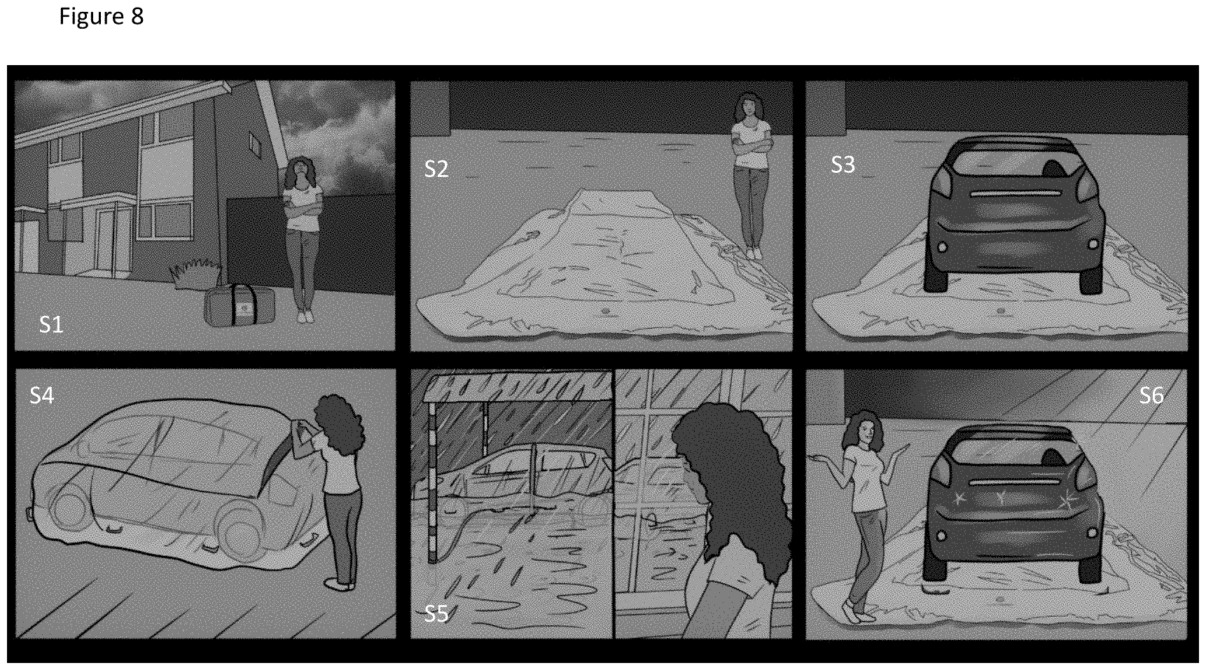

The present invention, as shown in FIG. 8 illustrates a user deploying the temporary protective enclosure. In step S1, the user is alerted of an upcoming weather condition and starts the deployment process by placing the temporary protective enclosure contained in its protective bag unto the ground. In step S2, takes the temporary protective enclosure out of its protective bag and lays it down on the ground with the top upper cover facing upwards and unzipping the upper top cover exposing the opening of the temporary protective enclosure. In step S3, the user then drives a vehicle over the temporary protective enclosure (using the guidelines) to center the vehicle over the floor mat. Alternatively, the user can move valuable objects into the temporary protective enclosure, laying them on top of the floor mat. In step S4, the user raises the flexible walls over the contents of the temporary protective enclosure and zips the cover to the bottom half of the temporary protective enclosure. The user can also close the flap on the edge of the cover and fasten it with the hook-and-loop fastener. Not pictured herein; however, the user takes an anchoring tether and loops it around the object sliding the anchoring tether through the handles. Once it is wrapped, the end carabiner is then clasped unto the anchoring tether closest to the temporary protective enclosure. The user then takes the other end of the anchoring tether and wraps it around a stationary object such as a light post. After tightly wrapping the anchoring tether around the light post, the user connects that free end, with a carabiner, unto the end of the anchoring tether closest to the stationary object. The user repeats the anchoring steps using another anchoring tether to secure and immobilize the contents of the temporary protective enclosure. Due to the high-quality, light weight PE used for this enclosure, a single user should complete the set-up (S1-S4) described within a few minutes. In step S5, the user sits out the inclement weather while the temporary protective enclosure remains stationary and protecting its contents. In step S6, the user reverses the steps to unzip the upper top cover and dropping the walls down to access the vehicle or the contents of the temporary protective enclosure. Later, the user can fold-up the temporary protective enclosure (not pictured) and store it in its designated storage bag.

This detailed description has been provided only for illustrative purposes. It is recognized that other embodiments maybe articulated without departing from the objects and scope of the present invention. Any such modifications and variations are meant to be within the scope of the invention as contained within the following claims.

What is claimed is:

1. A temporary protective enclosure deployable by a single individual, comprising:
a bottom part constructed of a woven-laminated flexible material that is water impermeable;
the bottom part consists of four collapsible walls and a floor mat;
each of the four collapsible walls and the floor mat are arranged in a constellation such that one edge of each wall connects to at least one edge of the floor mat;
the collapsible walls are bound together by heat welding them together where they overlap one another;
the collapsible walls and the floor mat are bound together by heat welding them together where they overlap one another;
the overlap created by the combination of the flexible walls to other flexible walls and/or the flexible walls to the floor mat, creates a seam that is completely covered by a water impermeable material using heat welding;
three of the collapsible walls that are bound together have their edge lining, opposite the side bounded to the floor mat, connected to a first membrane that includes a first zipper mating mechanism;
a top cover constructed from the woven-laminated flexible material;
one side of the top cover is connected to one of the collapsible walls that does not have the first membrane with the first zipper mating mechanism connected thereon;
the top cover and the one of the collapsible walls are bound together by heat welding them together where they overlap one another;
the overlap created by the combination of the top cover and the one of the collapsible walls creates a seam that is completely covered by the water impermeable material using heat welding;
the top cover's unconnected sides are connected to a second membrane that includes a second zipper mating mechanism; and
the first zipper mating mechanism and the second zipper mating mechanism come into contact with one another to fasten the bottom part and the top cover enclosing the temporary protective enclosure.

2. The temporary protective enclosure of claim 1, wherein:
multiple handles are heat welded onto an exterior side of at least one of the flexible walls and an exterior side of the top cover; and
the handles create seams that are covered by the water impermeable material using heat welding.

3. The temporary protective enclosure of claim 1, wherein the woven-laminated flexible material is a polyethylene of about 400 micrometers (μm) thickness.

4. The temporary protective enclosure of claim 3, wherein the woven-laminated flexible material is rated to withstand an average water pressure of 7,200 mmH₂O.

5. The temporary protective enclosure of claim 1, wherein:
the floor mat has reflective guide markings integrated within the interior section of the temporary protective enclosure; and
the woven-laminated flexible material used to construct the floor mat is thicker and/or created from a more abrasion-resistant substance.

6. The temporary protective enclosure of claim 1, wherein:
within the vicinity of the top cover's unconnected sides closer to the second membrane, the top cover is integrated with a flap running the length of the unconnected three sides of the top cover;
the flap is heat welded to the top surface of the top cover and the surface overlap that is created by the seam is heat welded with the water impermeable material and/or a breathable material; and
a hook of a hook-and-loop fastener is installed on the inside edge of the flap that drapes over both zipper mating mechanisms and fastens to a loop of the hook-and-loop fastener that is installed on the outside surface of the three collapsible walls.

7. The temporary protective enclosure of claim 1, wherein the first membrane and/or the second membrane are made of a breathable material.

8. The temporary protective enclosure of claim 1, further comprising:
anchoring tethers constructed from a sturdy material;
one end of each anchoring tether creates a loop by which a carabiner is connected thereon;
the other end of each anchoring tether creates another loop by which another carabiner is connected thereon;
the anchoring tethers wrap around the temporary protective enclosure once inserted through the handles;
the end of the anchoring tether wrapping around the temporary protective enclosure is clasped unto the tether itself; and
the other end of the anchoring tether is wrapped around a stationary object and then clasped unto the other end of the tether itself.

9. A method of deploying, by an individual, a temporary protective enclosure comprising the steps of:
unfurling the temporary protective enclosure by unfolding a bottom part of the temporary protective enclosure such that a floor mat faces the ground and a top cover faces to the sky;
opening the top cover by unzipping a zipper fastener located between the top cover and the bottom part;
placing an object inside the temporary protective enclosure by centering the object unto the floor mat;
raising the sides of the bottom part of the temporary protective enclosure over the object in order to completely or partially cover the object;
closing the temporary protective enclosure by aligning the top cover with the bottom part and zipping it using the zipper fastener;
draping over a flap located on the top cover on and over the zipper fastener and fastening the flap unto the bottom part using a hook-and-loop fastener;
taking one end of an anchoring tether and guiding it through a handle located on the top cover and/or the bottom part, wrapping it around the object placed inside the temporary protective enclosure;
that same end of the anchoring tether has a carabiner attached to the anchoring tether which is clasped unto the anchoring tether;
taking the other end of the anchoring tether and wrapping it tightly around a stationary object; and
that end of the anchoring tether has another carabiner attached to the anchoring tether which is then clasped unto the anchoring tether.
